(19) United States
(12) Patent Application Publication
(10) Pub. No.: US 2006/0125864 A1
(43) Pub. Date: Jun. 15, 2006

(54) Using a consumable component with an apparatus

(76) Inventors: John L. Westrum, Eden Prairie, MN (US); Brad S. Moen, Winsted, MN (US); Richard S. Gawlik, Andover, MA (US); John M. Smutek, Billerica, MA (US); Richard J. Hughes, Medway, MA (US)

Correspondence Address: FISH & RICHARDSON P.C., PO BOX 1022, MINNEAPOLIS, MN, 55440-1022, US

(21) Appl. No.: 11/012,895

(22) Filed: Dec. 15, 2004

(51) Int. Cl. B41J 29/38

(52) U.S. Cl. 347/14

(57) ABSTRACT

A consumable component designed to be usable with an apparatus has a surface that includes a non-reflective area forming a predefined pattern in a reflective material. Electromagnetic energy reflected from the surface and read by the apparatus contains a predefined characteristic. The apparatus is programmed not to consume the consumable component if the reflected electromagnetic energy does not contain the predefined characteristic. A system that includes the consumable component and a reader is disclosed. So are methods of using a system and of designing a label and providing it on a consumable component.

### TECHNICAL FIELD

This description relates to a consumable component and use thereof with an apparatus.

### BACKGROUND

There are many devices that use a consumable component. For example, an inkjet printer uses one or more cartridges to supply ink for printing. When the ink cartridge, a consumable component, has been consumed, it can be replaced with another equivalent component or it can be refilled and then replaced in the device. The consumable component typically has a shape, interface, contacts or other mating features that allow it to work properly with the device. In contrast, a component that lacks such features, for example one that has the wrong shape, typically cannot be used with the apparatus. Accordingly, the apparatus typically does not accept any consumable component that is not configured to be used with the apparatus.

There may, however, be reasons to have the device reject also some of the consumable components that are configured to be used with the apparatus. For example, a manufacturer may wish to ensure that a device is to be used only with approved components and not with components that are not approved. Non-approved components may lack important features or may otherwise be inferior compared to the approved components, to name a few examples. Thus, there is a need for a device that recognizes approved and non-approved components and that accepts only the former for use.

It has been proposed to use radio frequency identification (RFID) tags for such purposes, wherein an RFID tag contains a chip and a small antenna to allow communication with an RFID reader. It has also been proposed to use colored barcodes on the components and to read infrared light reflected from the barcodes. These approaches may, however, be associated with disadvantages in that the labels may be complicated or costly to produce. Another difficulty with consumable components made of plastic, such as an ink cartridge, is that the plastic may have complex dielectric properties. This means that if the plastic were targeted by electromagnetic waves, the cartridge may produce reflections that are inconsistent or difficult to predict. Another complication is that ink inside the cartridge also has dielectric properties and may affect wave reflection, particularly as the ink level in the cartridge decreases over time.

### SUMMARY

The invention relates to using a consumable component with an apparatus.

In a first general aspect, a system comprises an apparatus capable of consuming a consumable component, and a reader. The reader a) directs electromagnetic energy toward a surface of the consumable component that includes a non-reflective area forming a predefined pattern in a reflective material, b) receives reflected electromagnetic energy resulting therefrom, and c) determines whether the reflected electromagnetic energy contains a predefined characteristic. The apparatus is programmed not to consume the consumable component if the reflected electromagnetic energy does not contain the predefined characteristic.

In selected embodiments, the reader receives the reflected electromagnetic energy during movement of the consumable component. In other embodiments, the reflected electromagnetic energy may be received while the consumable component is stationary.

In selected embodiments, the apparatus comprises a printer. The consumable component may comprise one selected from the group consisting of: an ink cartridge, a toner cartridge, a resin ribbon for thermal transfer printing, and combinations thereof.

In a second general aspect, a consumable component designed to be usable with an apparatus has a surface that includes a non-reflective area forming a predefined pattern in a reflective material. Electromagnetic energy reflected from the surface and read by the apparatus contains a predefined characteristic. The apparatus is programmed not to consume the consumable component if the reflected electromagnetic energy does not contain the predefined characteristic.

In selected embodiments, a label having the surface is affixed to the consumable component. The label may include layers that are designed to be destroyed upon an attempt at removing the label.

In selected embodiments, the reflective material may include a hot-stamp metallized foil. The non-reflective area may comprise an opening in the reflective material, in which opening an absorbent or transparent material may be placed. The non-reflective area may comprise a material placed on top of the reflective material, which top material may be an absorbent material.

In a third general aspect, a method of using an apparatus that is capable of consuming a consumable component comprises directing electromagnetic energy toward a surface of the consumable component that includes a non-reflective area forming a predefined pattern in a reflective material, receiving reflected electromagnetic energy resulting therefrom, and determining whether the reflected electromagnetic energy contains a predefined characteristic, wherein the apparatus is programmed not to consume the consumable component if the reflected electromagnetic energy does not contain the predefined characteristic.

In selected embodiments, a reader that receives the reflected electromagnetic energy is configured to learn the predefined characteristic upon an initial consumable component being used with the apparatus.

In selected embodiments, the apparatus comprises a computer connected to a device capable of consuming the consumable component. The computer may be programmed to prevent consumption of the consumable component by the device if the reflected electromagnetic energy does not contain the predefined characteristic. The device may be programmed not to consume the consumable component if the reflected electromagnetic energy does not contain the predefined characteristic.

In a fourth general aspect, a method comprises designing a label and providing the label on a consumable component. The label includes a non-reflective area that forms a predefined pattern in a reflective material, wherein electromagnetic energy reflected from the label contains a predefined characteristic. The consumable component is designed to be useable with an apparatus that is programmed not to consume the consumable component if the reflected electromagnetic energy does not contain the predefined characteristic.

In selected embodiments, designing the label comprises selecting the predefined pattern so that the reflected electromagnetic energy contains the predefined characteristic.

In selected embodiments, designing the label may comprise forming the label with the predefined pattern, identifying the predefined characteristic, and programming the apparatus not to consume the consumable component if the reflected electromagnetic energy does not contain the predefined characteristic.

In selected embodiments, the reflected electromagnetic energy generates a voltage signal and the predefined characteristic comprises an amplitude change in the voltage signal. The method may comprise configuring a reader to identify at least one peak in the voltage signal and use the identified at least one peak in determining whether the reflected electromagnetic energy contains the predefined characteristic. The reader may be configured to identify at least first and second peaks in the voltage signal and determine whether the amplitude change is located between the first and second peaks in the voltage signal.

Advantages of the systems, components and methods described herein may include any or all of the following: Improving system recognition of approved components; improving labels to be used with an apparatus that does not accept all components that are configured to be useable with the apparatus; providing a flexible technique for labeling approved components; and providing labels that mask irregular or alternating dielectric properties of the component for a reliable reading.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of an embodiment of an inventive system;

FIG. 2 is a block diagram of another embodiment of the inventive system;

FIG. 3 shows components of a printer that can be included in an inventive system;

FIGS. 4A-E show examples of surfaces that can be used with inventive embodiments, each surface having a reflective material and a non-reflective area;

FIGS. 5A and B show examples of labels that can include any or all of the surfaces shown in FIGS. 4A-E;

FIGS. 6A-D are exemplary graphs showing signals generated upon receiving reflected electromagnetic energy in an inventive embodiment; and

FIGS. 7 and 8 are flow charts of embodiments of inventive methods.

Like reference numerals in the various drawings indicate like elements.

### DETAILED DESCRIPTION

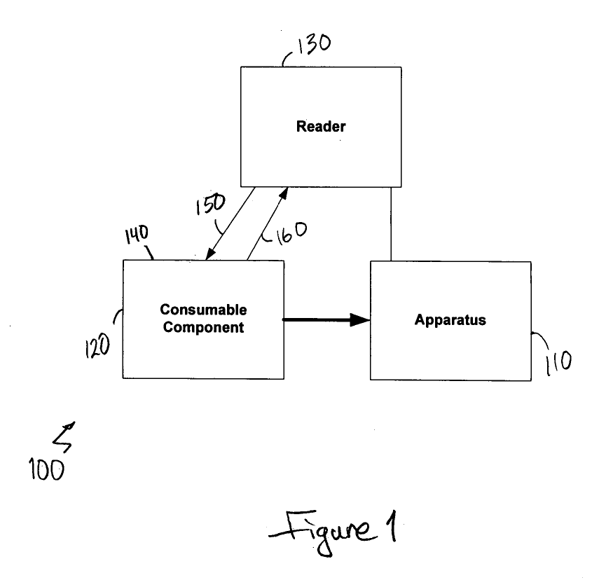

FIG. 1 shows a system 100 according to an inventive embodiment. The system 100 includes an apparatus 110 that is capable of consuming a consumable component 120. The system includes a reader 130 by which the system determines whether the apparatus should accept the component 120. The reader may direct electromagnetic energy toward a surface 140 of the consumable component as indicated by an arrow 150. It will be described later that the surface includes a non-reflective area forming a predefined pattern in a reflective material. The reader receives reflected electromagnetic energy resulting therefrom as indicated by an arrow 160. The reader determines whether the reflected electromagnetic energy contains a predefined characteristic. The apparatus is programmed not to consume the consumable component if the reflected electromagnetic energy does not contain the predefined characteristic. Accordingly, the apparatus 110 will consume the component 120 if the reader 130 detects the predefined characteristic.

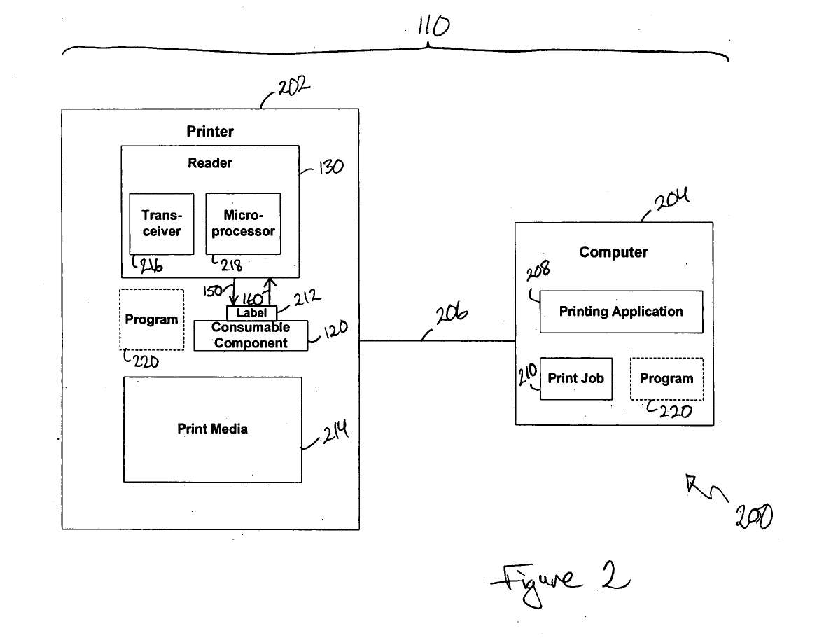

FIG. 2 shows another system 200. Here, the apparatus 110 includes a printer 202 that is connected to a computer 204 through a connection 206, such as a Universal Serial Bus (USB) cable or any kind of network. The computer includes a printing application 208 by which a user can create content for the printer to print. Printing may be initiated upon the computer generating a print job 210 to be sent to the printer.

In this example, the consumable component 120 may provide ink, toner or resin, to name a few examples, for the printing. That is, the consumable component may be an ink cartridge, a toner cartridge, a resin ribbon for thermal transfer printing, and combinations thereof, loaded with its respective material. When the consumable material in the component runs out, a new or refilled component may be used instead. Thus, the consumable component may consist of one part that the apparatus 110 consumes during operation, such as the ink, and another part that remains after consumption, such as the empty cartridge.

Here, a label 212 includes the surface toward which the reader directs electromagnetic energy. The arrows 150 and 160 are therefore shown between the reader 130 and the label 212. The label may be affixed to the consumable component with an adhesive. The label 212 is placed on all approved components; that is, on all components that the system should accept. Accordingly, any and all ink cartridges sold by a particular manufacturer can be provided with the label 212 such that the system will accept them.

When the reader receives the reflected electromagnetic energy, it determines whether the reflected electromagnetic energy contains the predefined characteristic. If so, the printer 202 will perform the print job 210. This may involve printing an image on one or more items of print media 214, which may be any media capable of being printed, such as paper or plastic. Particularly, the print media 214 may be a machine-readable disk such as a CD or a DVD, and the printer can then be used to print an image on one or more CDs or DVDs.

The electromagnetic energy directed at the surface, as indicated by the arrow 150, may essentially comprise microwaves, which may include electromagnetic waves having a frequency of 1-100 gigahertz (GHz). The reader may include a transceiver 216 that generates microwaves of a frequency of about 24 GHz and that is capable of receiving reflected waves resulting therefrom. For example, a “K Band Gunn Transceiver Module” available from Ameleks Corp. in Taipei, Taiwan may be used. The reader may include a microprocessor 218 that receives a signal that the transceiver 216 outputs. The microprocessor may process, digitize and analyze the signal and produce an output that indicates whether the reflected electromagnetic energy contains the predefined characteristic. In other implementations, electromagnetic waves with frequencies higher than 100 GHz may be used.

The apparatus 110 is programmed such that it does not consume the component if the reflected electromagnetic energy does not contain the predefined characteristic. This programming may provided through a program 220 that includes executable instructions such as computer code.

The program 220 may be executed on the printer 202 or on the computer 204. The following is an example of execution on the printer. A user of the computer 204 causes the printing application 208 to generate the print job 210. The computer sends the print job to the printer which in this example has the program 220. The program instructs the printer to verify the label 212 on the consumable component 120 before initiating the print job. If the reader finds that the label is acceptable, it initiates printing onto the print media 214. If the reader finds that the label is not acceptable, it sends an error message to the computer, which in turn may display a message to the user that the printing failed. Optionally, the printer makes several attempts at reading the label 212. Accordingly, the printer can be programmed not to consume the component if the reflected electromagnetic energy does not contain the predefined characteristic.

The following is an example of executing the program on the computer 204. A user causes the printing application 208 to generate the print job 210 on the computer 204 which in this example has the program 220. The program 220 instructs the computer that the label 212 should be verified before the computer sends the print job. The computer therefore triggers the printer to check the label. The printer, in turn, may use the reader to determine whether electromagnetic energy reflected from the label contains the predefined characteristic. The printer sends the result of this determination to the computer through the connection 206. If the label is acceptable, the computer sends the print job to the printer. If not, the computer may display a message to the user. Accordingly, the computer can be programmed to prevent consumption of the consumable component by the device if the reflected electromagnetic energy does not contain the predefined characteristic.

As described, the reader is configured to recognize the predefined characteristic. This configuration may take place during manufacture of the reader or later. For example, a manufacturer of the system 200 may know what labels will be used with the consumable component 120. The manufacturer can therefore make sure that the reader, when delivered, already has the capability to recognize that specific label. In contrast, the reader may be designed to learn the predefined characteristic from a component when it is first put in use. That is, when an initial consumable component is used with the apparatus 110, the reader may detect the predefined characteristic from a label on that component. Moreover, the reader may be configured to recognize several predefined characteristics, and the apparatus may then be programmed not to consume the consumable component unless the reflected electromagnetic energy contains at least one of the several predefined characteristics.

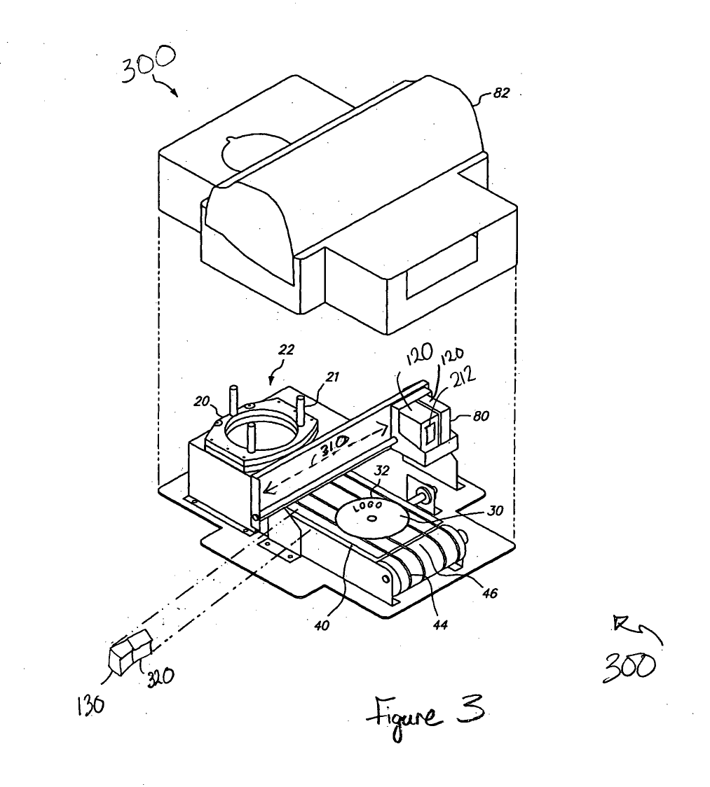

FIG. 3 shows a system 300 according to an embodiment of the invention. The system 300 is an in-line marking system for marking on media such as CDs and DVDs. The system includes a dispenser 20 for media, a conveyor belt assembly 40 to position the media for marking, a marking device 80 that marks on the media, and a cover 82. The marking device 80 may be a silk screen printer, a printer utilizing ink jet printing technology, a labeling process, or a thermal printing process. As additional examples, the marking device 80 can be a duplicating or a replicating device.

Here, two consumable components 120 are placed in the marking device 80. The consumable components may be a color ink cartridge having the label 212 affixed to it and a black ink cartridge without a label. The marking device 80 is designed to move along a path 310 during the marking process. The reader 130 is positioned toward one end of the path 310 to check if the label 212 is approved. Here, the reader is configured to look for a valid label only on the color cartridge, not on the black ink cartridge.

The reader may continuously generate the electromagnetic energy and may require prompting to process any reflected energy. Accordingly, an optical detector 320 may be positioned next to the reader to determine when the marking device, including the component with the label, passes by the reader. Upon triggering by the detector, the reader receives the reflected electromagnetic energy while the consumable component moves past the reader. The reader then determines whether the reflected electromagnetic energy contains the predefined characteristic. If so, the marking process is initiated.

The following is an example of the marking process. The dispenser 20 dispenses a markable medium 30 from a housing 22 onto the conveyor belt assembly 40. The conveyor belt assembly 40 receives the medium 30 from the dispenser 20 and conveys the medium 30 from a first position to a second position. The conveyor belt assembly 40 has a plurality of belts 44 forming a conveyor surface 46. The marking device 80, located between the first position and the second position of the conveyor belt assembly, marks the medium 30 with indicia 32. The indicia 32 can include names, logos, trademarks, text, graphics, bar codes, designs or any other descriptive or unique marking to identify or associate the medium with a manufacturer or for identification of the content of the medium, marketing, sales and cataloging of information. The cover 82 prevents the dispenser 20, the conveyor belt assembly 40 and the marking device 80 from being damaged during transportation or use and further prevents dust and other particles from collecting on the dispenser 20, conveyor belt assembly 40, or marking device 80. The label 212 may be verified before each marking process.

When the system includes several consumable components at once, the reader may be configured to evaluate at least some of the several consumable components by directing electromagnetic energy, receiving the reflection, and determining whether it contains the predefined characteristic. In this example, the system verifies only the label on the color cartridge. Alternatively, the reader checks every consumable component in the system.

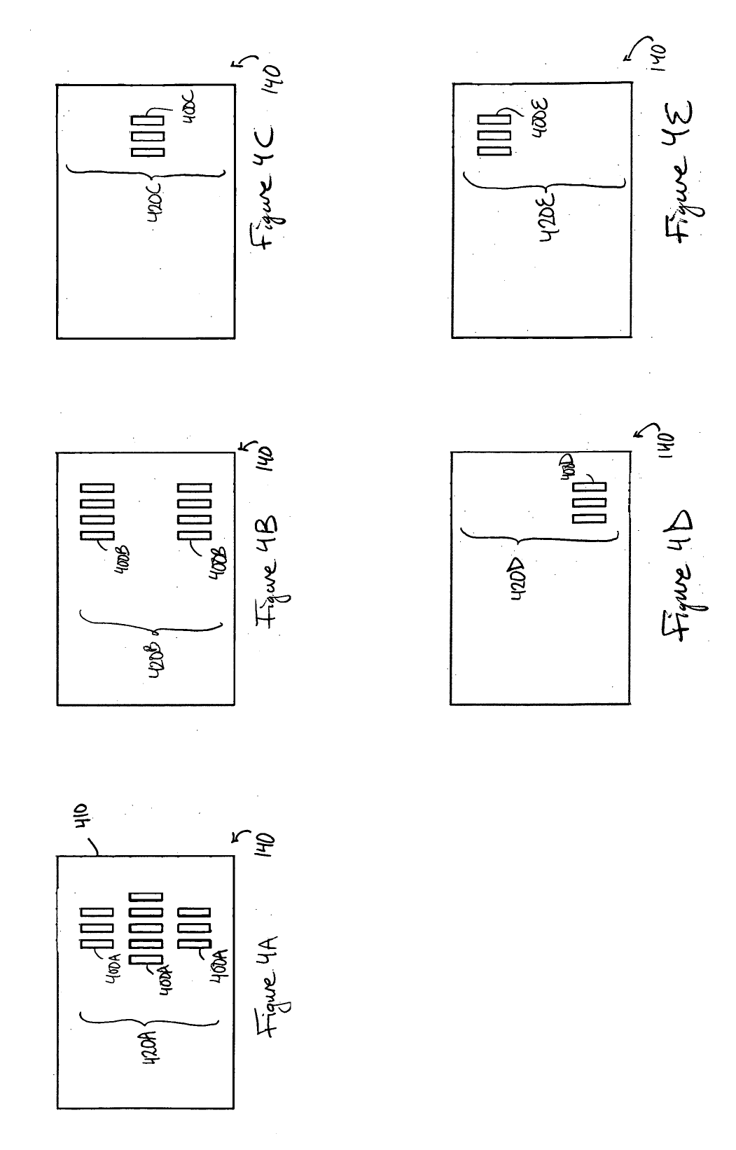

FIGS. 4A-E are examples of the surface 140 (see FIG. 1). The surface 140 includes at least one non-reflective area 400 forming a predefined pattern in a reflective area 410. For example, FIG. 4A includes non-reflective areas 400A. The surface 140 is to be the target of the electromagnetic energy generated by the reader, and the material 410 is therefore designed to be generally reflective for the energy that is to be used. That is, if the reader generates 24 GHz microwaves, the material 410 should reflect a significant portion of the waves that fall on it but may not reflect all of the impinging energy. Similarly, the non-reflective area 400 should be designed so that it does not reflect a significant portion of the incoming energy that falls on it. Rather, the area should absorb or transmit a significant portion of the energy.

The reflective material may include a metal foil. For example, the metal foil may be formed using a conventional hot-stamping metallizing technique. The metal foil may have any color or may have its natural metal finish. The non-reflective area 400 may be an opening in the reflective material or may be a material placed on top thereof, as will be described below. An exemplary size of the surface 140 is 1.60 by 1.10 inches.

The at least one non-reflective area 400 forms a predefined pattern 420 in the reflective area. For example, the areas 400A form a pattern 420A. Similarly, non-reflective areas 400B form predefined pattern 400B, non-reflective areas 400C form predefined pattern 400C, non-reflective areas 400D form predefined pattern 400D, and non-reflective areas 400E form predefined pattern 400E. The pattern in the reflective surface typically affects the reflected energy, so the reflections received from the respective surfaces in FIGS. 4A-E may be different. This means that one of the shown surfaces may be capable of producing the reader-recognized predefined characteristic while others are not.

The surface proportion between the reflective material 410 and the non-reflective area 400 may affect the reading. Having the reflective material cover a large portion of the surface 140 may help mask unknown (and possibly varying) dielectric properties of the consumable component on which the surface is located. A large reflective area can provide a generally strong reflective signal for the reader. Yet the presence of the predefined pattern of non-reflective area in the reflective material can produce a perturbation in the reflected signal—the predefined characteristic-that the reader can detect. Accordingly, it may be advantageous to design the label such that the reflective material extends throughout most of the label and such that the non-reflective area is relatively small compared to the reflective area, for example along the lines of any of the examples in FIGS. 4A-E.

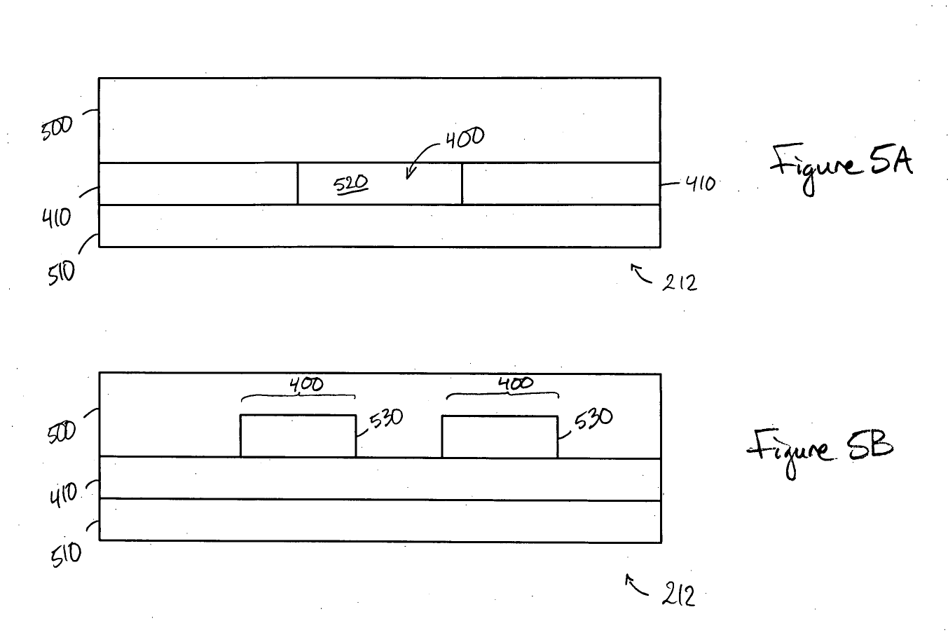

The following are examples of the label 212. As shown in FIG. 5A, the label may include the reflective material 410 between a top layer 500 and a bottom layer 510. The layers 500 and 510 may be produced from paper, plastic or any other material suitable for a label. Particularly, the layers can be made from a material that is designed to be destroyed if someone attempts to remove the label from the consumable component. An example of such a material is destructible vinyl. The bottom layer 510 may be designed for affixing the label 212 to the consumable component, for example using an adhesive.

The non-reflective area 400 may comprise at least one opening in the reflective material. FIG. 5A shows the non-reflective area 400 between the top and bottom layers. The opening may be created by removing a portion of the reflective material. The opening forms the predefined pattern in the reflective material. In some implementations, a material 520 is placed in the opening. This may be a material that is transparent to the electromagnetic energy, a material that is absorbent to the electromagnetic energy, and combinations thereof.

Another example is shown in FIG. 5B, where the non-reflective areas 400 comprise a material 530 placed on top of the reflecting material 410. Here, the material 530 is shown between the reflecting material 410 and the top layer 500. The material 530 is absorbent to the electromagnetic energy that the reader directs at the label. For example, the material 530 may include ECCOSORB material available from Emerson and Cuming Microwave Products in Randolph, Mass. Thus, the material 530 forms the predefined pattern in the reflective material 410.

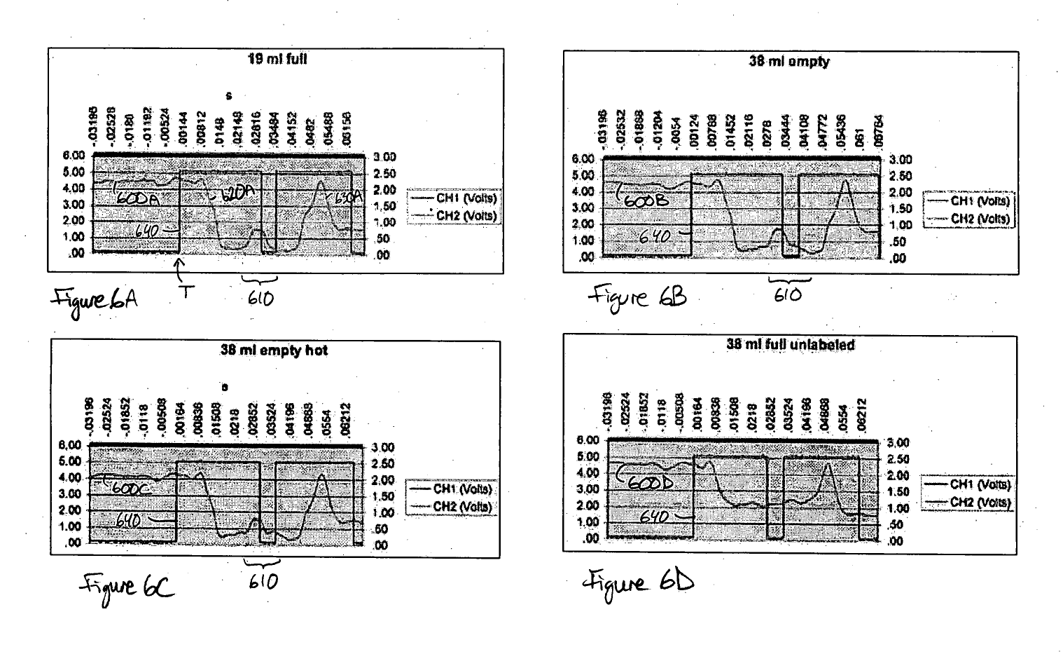

FIGS. 6A-D show examples of how the reader can determine whether the reflected electromagnetic energy contains the predefined characteristic. Each of these figures shows a graph generated upon the reader receiving reflected electromagnetic energy as the component passes by the reader. The reader generates voltage signals 600A-D that correspond to the respective received energies. The graphs show a voltage signal (in Volts) as a function of time (in seconds). As indicated by the legends in the respective graphs, signal 600A was received from a full 19 milliliter (ml) ink cartridge, the signal 600B from an empty 38 ml cartridge, and the signal 600C from a hot empty 38 ml cartridge. The signals 600A-C were received from cartridges with approved labels. The signal 600D was received from a full 38 ml cartridge without an approved label.

The predefined characteristic may be an amplitude change 610 in the voltage signal. Here, the amplitude change 610 is visible as a small peak or hump in the voltage signal. The amplitude change is caused by the predefined pattern of the non-reflective area passing in front of the reader. The signal 600D, in contrast, has no such feature. Accordingly, the reader can search for the amplitude change 610 to determine if the component has an approved label.

The reader may use another feature of the received signal in making this determination. For example, each of the signals (including the signal 600D) includes peaks that have been labeled first peak 620A and second peak 630A in FIG. 6A. The reader may use at least one of these peaks. For example, the reader may identify the presence of the first and second peaks and thereafter determine whether an amplitude change is located between them.

The optical detector 320 (see FIG. 3) may also be used. Each of the voltage graphs in FIGS. 6A-D include a second voltage signal 640 that is generated upon the label 212 passing in front of the optical detector. A leading edge of the second voltage signal occurs at a time T (see FIG. 6A). This indicates the moment when the label is optically detected. The reader can be configured to identify the leading edge, and from there attempt to find one or more of the first and second peaks. Starting from the leading edge, the reader can move a fixed amount of time—such as 12.5 milliseconds—“later” (i.e., to the right) in the graph and begin looking for the peaks. Having identified the peaks, the reader determines whether there is a predefined characteristic, such as the amplitude change 610, between them.

In the above examples regarding FIGS. 3 and 6A-D, the reading is performed while the consumable component moves relative to the reader. In the in-line marking system 300 the reader uses the movement of the component(s) along the path 310, which is part of the normal operation of that system. In other systems, the reader can move relative to the consumable component.

In addition, the reader can perform its operations without relative movement between the reader and the consumable component; that is, while the consumable component is stationary relative to the reader. This can be done by having the reader direct the electromagnetic energy toward at least two portions of the surface 140 and receiving respective portions of the reflected electromagnetic energy from the two surface portions. Consider for example the surface 140 as shown in any of the exemplary FIGS. 4A-E. It contains at least one non-reflective area 400 and a reflective material 410. By directing the energy at an area that is expected to be non-reflective, it can be expected that the received signal should be relatively weak, or “low”. In contrast, directing the energy at an area that is expected to be reflective should produce a relatively strong, or “high” signal. Any pair of signals that can be obtained from the two surface portions (low-low, low-high, high-low and high-high) can constitute the predefined characteristic. Measurements can be performed on more than two portions of the surface. Thus, the reader can determine the presence or absence of the predefined characteristic in a stationary component.

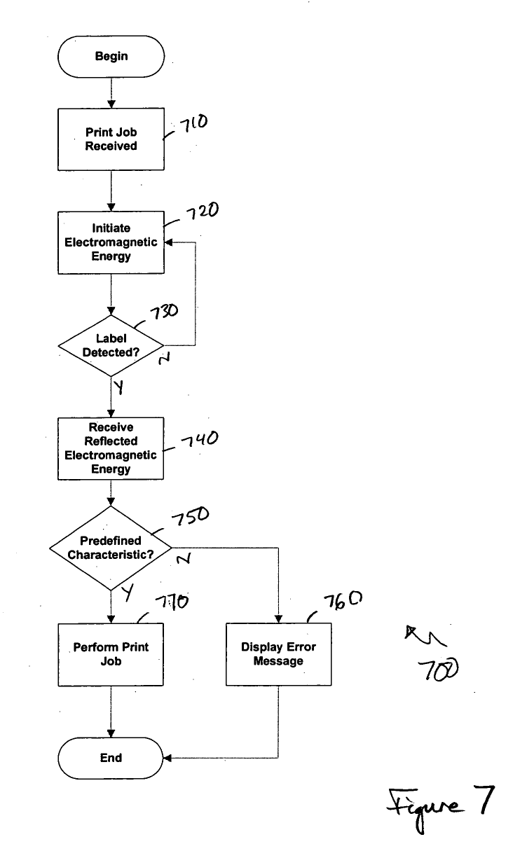

FIG. 7 is a flow chart of a method 700 that can be performed in the system 200, for example, and this description therefore also refers to FIG. 2. The method 700 may begin with a print job being received in step 710. For example, the apparatus 110 may include the computer 204 that sends the print job 210 to the printer 202.

The reader may begin generating electromagnetic energy in step 720. In some implementations, the reader 130 continuously generates such energy while the system is on. The energy may be directed toward a place where a label is expected to be. However, the label may be absent, for example if there is no component, if the component is unlabeled, or if the component has not yet moved in front of the reader.

The method therefore determines, in decision step 730, whether a label has been detected. For example, an output from the optical detector 320 can be used. If no label has been detected, the method may return to step 720 and from there again to step 730, and so on.

If a label is detected in step 730, the reader receives reflected electromagnetic energy in step 740. The reader may need triggering to begin registering the received energy.

In step 750, the reader determines whether the reflected electromagnetic energy contains the predefined characteristic. For example, this may involve looking for the amplitude change 610 in the voltage signal 600. If the energy does not contain the characteristic, an error message may be displayed to the user in step 760. More than one attempt to read the label may be made.

If the energy does contain the characteristic, the method may continue with performing the print job in step 770. This may involve marking the medium 30 with the indicia 32, as described with reference to FIG. 3. In some implementations, the print job is provided to the printer only after verifying that the component has an approved label. In such implementations, the step 710 may be performed immediately after determining, in step 750, that the label is approved. The method 700 may be performed for each print job.

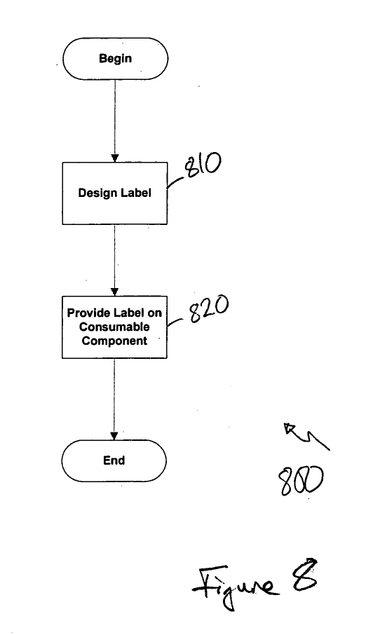

FIG. 8 is a flow chart of a method of designing a label and providing the label on a consumable component. This method may be performed by a manufacturer of a system such as system 100 or 200. The label is designed in step 810. This may involve selecting the predefined pattern 420 that the non-reflective area 400 should form in the reflective material 410. Any of the patterns 420A-E shown in FIGS. 4A-E may be chosen, to name a few examples. When the selected pattern has previously been used, it may be known from that use what is the predefined characteristic for that pattern. Accordingly, the pattern may be selected so that the reflected electromagnetic energy contains the predefined characteristic.

As another example, step 810 may involve selecting a new pattern and thereafter determining a characteristic thereof. That is, the label may be produced with the selected new pattern and at least one characteristic may then be determined in energy reflected from the produced label. Such a characteristic should distinguish a reading of the label from a reading of an unapproved label or of a non-label. The characteristic can be identified by analyzing voltage signals such as those shown in FIGS. 6A-D. Such an identified characteristic can thereafter be used as the predefined characteristic for labels having the new pattern. The apparatus 110 is programmed not to consume the consumable component if the reflected electromagnetic energy does not contain the predefined characteristic.

In step 820, the label is provided on the consumable component that is designed to be useable with the apparatus. For example, the label can be affixed to the consumable component using adhesive. Identical labels can be provided on many components, such as on all those from a single vendor.

A number of embodiments of the invention have been described. Nevertheless, it will be understood that various modifications may be made without departing from the spirit and scope of the invention. The consumable components are not limited to ink or toner cartridges but include batteries, storage media and containers of beverage concentrate for drink dispensers, to name a few examples. Accordingly, other embodiments are within the scope of the following claims.

What is claimed is:

1. A system comprising:
an apparatus capable of consuming a consumable component; and
a reader that a) directs electromagnetic energy toward a surface of the consumable component that includes a non-reflective area forming a predefined pattern in a reflective material, b) receives reflected electromagnetic energy resulting therefrom, and c) determines whether the reflected electromagnetic energy contains a predefined characteristic, wherein the apparatus is programmed not to consume the consumable component if the reflected electromagnetic energy does not contain the predefined characteristic.

2. The system of claim 1, wherein the apparatus comprises a printer, and wherein the consumable component contains matter that the printer consumes.

3. The system of claim 1, wherein the reader includes a transceiver configured to generate the electromagnetic energy and receive the reflected electromagnetic energy.

4. The system of claim 3, wherein the reader further includes a microprocessor configured to receive a signal from the transceiver, the signal corresponding to the reflected electromagnetic energy.

5. The system of claim 1, wherein the apparatus comprises a computer connected to a device capable of consuming the consumable component, and wherein the computer is programmed to prevent consumption of the consumable component by the device if the reflected electromagnetic energy does not contain the predefined characteristic.

6. The system of claim 1, wherein the apparatus comprises a computer connected to a device capable of consuming the consumable component, and wherein the device is programmed not to consume the consumable component if the reflected electromagnetic energy does not contain the predefined characteristic.

7. The system of claim 1, wherein the system includes several consumable components at once, and wherein the reader is configured to perform the steps a), b) and c) for at least some of the several consumable components.

8. The system of claim 1, wherein the reflected electromagnetic energy is received during movement of the consumable component relative to the reader.

9. The system of claim 1, wherein the reflected electromagnetic energy is received while the consumable component is stationary relative to the reader.

10. The system of claim 9, wherein the reader directs the electromagnetic energy toward at least two portions of the surface and receives respective portions of the reflected electromagnetic energy from the at least two portions of the surface.

11. The system of claim 1, wherein the consumable component includes a label having the surface that includes the non-reflective area forming the predefined pattern in the reflective material.

12. The system of claim 11, wherein optical detection of the label triggers the reader to receive the reflected electromagnetic energy.

13. The system of claim 1, wherein the electromagnetic energy essentially comprises microwaves.

14. The system of claim 1, wherein the reflected electromagnetic energy generates a voltage signal in the reader and wherein the predefined characteristic comprises an amplitude change in the voltage signal.

15. The system of claim 14, wherein in step c) the reader identifies at least one peak in the voltage signal and uses the identified at least one peak in determining whether the reflected electromagnetic energy contains the amplitude change.

16. The system of claim 15, wherein the reader identifies first and second peaks in the voltage signal and determines whether the amplitude change is located between the first and second peaks in the voltage signal.

17. The system of claim 1, wherein during manufacture of the system the reader is configured to recognize the predefined characteristic.

18. The system of claim 1, wherein the reader learns the predefined characteristic upon an initial consumable component being used with the apparatus after manufacture of the system.

19. The system of claim 1, wherein the reader is configured to recognize several predefined characteristics and wherein the apparatus is programmed not to consume the consumable component unless the reflected electromagnetic energy contains at least one of the several predefined characteristics.

20. A consumable component designed to be usable with an apparatus, the consumable component having a surface that includes a non-reflective area forming a predefined pattern in a reflective material, wherein electromagnetic energy reflected from the surface and read by the apparatus contains a predefined characteristic and wherein the apparatus is programmed not to consume the consumable component if the reflected electromagnetic energy does not contain the predefined characteristic.

21. The consumable component of claim 20, wherein the reflective material is a hot-stamp metallized foil.

22. The consumable component of claim 20, wherein the non-reflecting area comprises at least one opening in the reflective material.

23. The consumable component of claim 22, wherein a material is placed in the at least one opening, the material being selected from the group consisting of: a material transparent to the electromagnetic energy, a material absorbent to the electromagnetic energy, and combinations thereof.

24. The consumable component of claim 20, wherein the non-reflecting area comprises a material placed on top of the reflective material, the material being absorbent to the electromagnetic energy.

25. The consumable component of claim 20, wherein the consumable component comprises one selected from the group consisting of: an ink cartridge, a toner cartridge, a resin ribbon for thermal transfer printing, and combinations thereof.

26. The consumable component of claim 20, wherein the non-reflective area forming the predefined pattern is designed to interact with the electromagnetic energy to produce the predefined characteristic in the reflected electromagnetic energy.

27. The consumable component of claim 20, wherein a label is affixed to the consumable component, the label having the surface that includes the non-reflective area forming the predefined pattern in the reflective material.

28. The consumable component of claim 27, wherein the reflective material extends throughout most of the label and wherein the non-reflective area is relatively small compared to the reflective material.

29. The consumable component of claim 28, wherein the label is designed such that the apparatus is capable of recognizing the predefined characteristic in the reflected electromagnetic energy despite unfavorable dielectric properties of the consumable component.

30. The consumable component of claim 27, wherein the label further comprises a top layer above the surface and a bottom layer below the surface, the bottom layer being designed for affixing the label to the consumable component.

31. The consumable component of claim 30, wherein the top and bottom layers are made of a material that is designed to be destroyed upon an attempt at removing the label from the consumable component.

32. A method of using an apparatus that is capable of consuming a consumable component, the method comprising:
directing electromagnetic energy toward a surface of the consumable component that includes a non-reflective area forming a predefined pattern in a reflective material;
receiving reflected electromagnetic energy resulting therefrom; and
determining whether the reflected electromagnetic energy contains a predefined characteristic, wherein the apparatus is programmed not to consume the consumable component if the reflected electromagnetic energy does not contain the predefined characteristic.

33. The method of claim 32, further comprising configuring a reader to recognize the predefined characteristic.

34. The method of claim 33, wherein the reader is configured to learn the predefined characteristic upon an initial consumable component being used with the apparatus.

35. The method of claim 32, performed each time the consumable component is to be used with the apparatus.

36. The method of claim 32, performed upon detecting a label that is affixed to the consumable component, the label having the surface that includes the non-reflective area forming the predefined pattern in the reflective material.

37. The method of claim 32, wherein the apparatus comprises a computer connected to a device capable of consuming the consumable component, further comprising programming the computer to prevent consumption of the consumable component by the device if the reflected electromagnetic energy does not contain the predefined characteristic.

38. The method of claim 32, wherein the apparatus comprises a computer connected to a device capable of consuming the consumable component, further comprising programming the device not to consume the consumable component if the reflected electromagnetic energy does not contain the predefined characteristic.

39. The method of claim 32, wherein the apparatus comprises a printer and wherein the consumable component comprises one selected from the group consisting of: an ink cartridge, a toner cartridge, a resin ribbon for thermal transfer printing, and combinations thereof.

40. The method of claim 39, wherein the printer is designed to print an image on a machine readable disk.

41. A method comprising:
designing a label, the label including a non-reflective area that forms a predefined pattern in a reflective material, wherein electromagnetic energy reflected from the label contains a predefined characteristic; and
providing the label on a consumable component designed to be usable with an apparatus that is programmed not to consume the consumable component if the reflected electromagnetic energy does not contain the predefined characteristic.

42. The method of claim 41, wherein designing the label comprises selecting the predefined pattern so that the reflected electromagnetic energy contains the predefined characteristic.

43. The method of claim 41, wherein designing the label comprises forming the label with the predefined pattern, identifying the predefined characteristic, and programming the apparatus not to consume the consumable component if the reflected electromagnetic energy does not contain the predefined characteristic.

44. The method of claim 43, wherein the reflected electromagnetic energy generates a voltage signal and the predefined characteristic comprises an amplitude change in the voltage signal.

45. The method of claim 44, further comprising configuring a reader to identify at least one peak in the voltage signal and use the identified at least one peak in determining whether the reflected electromagnetic energy contains the predefined characteristic.

46. The method of claim 45, wherein the reader is configured to identify at least first and second peaks in the voltage signal and determine whether the amplitude change is located between the first and second peaks in the voltage signal.
